(19) United States
(12) Patent Application Publication
(10) Pub. No.: US 2019/0019264 A1
(43) Pub. Date: Jan. 17, 2019

(54) FAMILY-DIRECTED INMATE DEBIT ACCOUNT FUNDING

(71) Applicant: GLOBAL TEL*LINK CORPORATION, Reston, VA (US)

(72) Inventor: Stephen L. HODGE, Aubrey, TX (US)

(21) Appl. No.: 15/646,967

(22) Filed: Jul. 11, 2017

(51) Int. Cl. G06Q 50/26; G06Q 20/40; G06Q 20/10; G06Q 20/26

(52) U.S. Cl. CPC G06Q 50/26; G06Q 20/4014; G06Q 20/405; G06Q 20/26; G06Q 20/108

(57) ABSTRACT

The present disclosure provides details of a system and method for a family-directed Inmate Debit account funding. The Inmate Debit account can be used by depositors such as family members and friends to transfer funds to an inmate, while the family members and friends are able to control the usage of the funds by the inmate. Partitions are created in the Inmate Debit account by the depositor and the depositor is able to apply different usage restriction rules on desired partitions to restrict the usage of the funds in the partitions. Depositor has the authority to modify the usage restriction rules as the depositor desires, and the inmate can only use the funds according to the usage restriction rules. Information of the depositor is collected by the disclosed system and method to improve the service and security of the institute.

### BACKGROUND

### Field

The disclosure relates to a system and method for family-directed inmate debit account funding.

### Background

In today's correctional facilities, an inmate can access and manage funds for different uses through various accounts. Common payment methods/accounts include Collect Call, Prepaid Collect, Debit Account, and Commissary Account. Among these accounts, Collet Call is facilitated by billing called party through the Local Exchange Carrier, Prepaid Collect is a prepaid account set up by a family member/friend with an institution for an inmate to make phone calls, Debit account is an account established by an inmate to make phone calls, and Commissary account is an account for an inmate's commissary purchase.

Often, an inmate manages his/her Debit account and has the authority to use the funds in the Debit account as he/she likes. A depositor, depositing funds to an inmate's Prepaid Collect, controls the funds in the Prepaid Collect account.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of an Inmate Debit account system, according to embodiments of the present disclosure.

FIG. 2 illustrates certain database tables used in Inmate Debit account system, according to embodiments of the present disclosure.

FIG. 3 illustrates certain other database tables used in Inmate Debit account system, according to embodiments of the present disclosure.

FIG. 4 illustrates a block diagram of site server or remote server, according to embodiments of the present disclosure.

FIG. 5 illustrates a flowchart diagram of method of registering with and depositing funds into Inmate Debit account system, according to embodiments of the present disclosure.

FIG. 6 illustrates a flowchart diagram of method of accessing funds in Inmate Debit account system, according to embodiments of the present disclosure.

FIG. 7 illustrates a flowchart diagram of method of collecting depositor information in Inmate Debit account system, according to embodiments of the present disclosure.

FIG. 8 illustrates a computer system, according to exemplary embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Overview

Using conventional payment accounts, it is difficult for a depositor to control the usage of funds that are transferred to the inmate in interest. As a result, undesired spending occurs.

In light of the above, the present disclosure provides details of a system and method for an Inmate Debit account. The Inmate Debit account can be used by depositors such as family members and friends to transfer funds to an inmate, while the family members and friends are able to control the usage of the funds by the inmate. Partitions are created in the Inmate Debit account by the depositor and the depositor is able to apply different usage restriction rules on desired partitions to restrict the usage of the funds in the partitions. Depositor has the authority to modify the usage restriction rules as the depositor desires, and the inmate can only use the funds according to the usage restriction rules. Information of the depositor is collected by the disclosed system and method to improve the service and security of the institute.

### Inmate Debit Account System

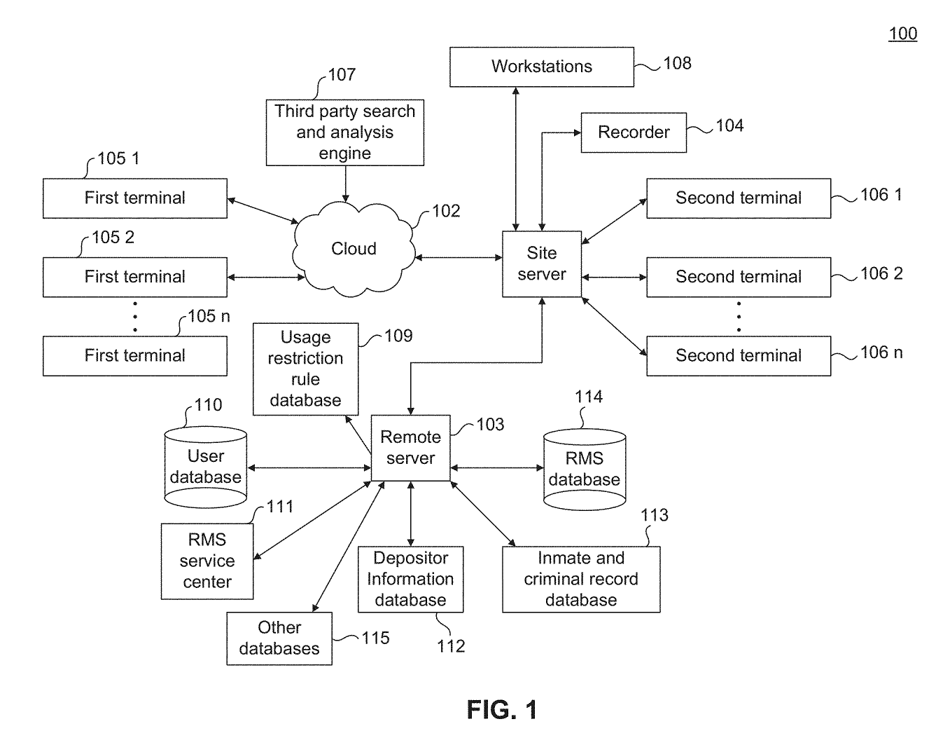

FIG. 1 illustrates a block diagram of an Inmate Debit account system 100, according to embodiments of the present disclosure. In an embodiment, as shown by FIG. 1, the inmate debit account system includes a site server 101, a cloud 102, a remote server 103, a recorder 104, a plurality of first terminals 105 1-n, a plurality of second terminals 106 1-n, a third party 107, workstations 108, a usage restriction rule database 109, a user database 110, a revenue management system (RMS) service center 111, a depositor information database 112, an inmate and criminal record database 113, an RMS database 114, and other databases 115. System 100 facilitates a depositor, e.g., family or friend, to deposit funds into an inmate's account and control how the funds are used by the inmate. Double-headed arrows in FIG. 1 represent suitable connections that allow bi-directional data transmission.

Site server 101 includes any suitable computer system capable of serving as the main processing unit for system 100. Site server 101 is connected to cloud 102, remote server 103, second terminals 106 1-n, recorder 104, and workstations 108. Site server 101 has the ability to process phone call requests, direct inquiries, and control funds transfer. Site server 101 also has the ability to log and record details of all phone calls placed from second terminals 106 1-n and store them for a period of time defined by the institution. Site server 101 is also capable of communicating with workstations 108 such that workstations 108 can create, edit, and monitor user accounts and phone calls. For example, workstations 108 may listen to the outgoing phone calls in real time or access calls stored on site server 101, or another type or database or storage means. Recorder 104 can be integral to system 100 or remote to site server 101. Recorder 104 is responsible for recording phone calls and storing them in one or more databases depending on the size of the institution or the amount of data which must be archived by the institution and the capability of the storage means.

Second terminals 106 1-n are capable of receiving phone call requests and inmate input, bi-directionally interacting with site server 101, and displaying account information to the inmate. Second terminals 106 1-n include one or more of a conventional telephone, a mobile device, a computer, a kiosk, and the like. Second terminals 106 1-n include suitable software and hardware for receiving user input and transmitting the user input to site server 101 for further processing, such as identity authentication. In some embodiments, a second terminal 106 n includes biometric sensors for sampling users' biometric inputs. In some embodiments, a second terminal 106 n includes a card reader to extract identity information of a user. In various embodiments, users/inmates are required to enter certain information, e.g., biometric input and personal information, to access and manage user accounts.

Workstations 108, recorder 104, and second terminals 106 1-n are connected to site server 101 via any suitable computer networks or other communication networks via local area network (LAN) protocols, e.g., Ethernet, Asynchronous Transfer Mode (ATM), Token Ring, and Fiber Distributed Data Interface (FDDI), and T-carriers. Through second terminal 106 n, a user/calling party can make phone calls to a called party associated with a first terminal 105 n, check account balance, and/or interact with inquiries and prompts sent by site server 101.

Cloud 102 facilitates communication between site server 101 and first terminals 105 1-n, and between site server 101 and third party search and analysis engine 107. Cloud 102 includes any suitable software and hardware that allow bi-directional data, to be transmitted. For example, cloud 102 includes one or more servers, at least one data control device, e.g., gateway, at least one data routing device, e.g., router, and a switchboard device. Thus, cloud 102 is capable of routing telephone calls and internet calls, performing voice prompts, and responding to menu selections. Conventional telephone calls placed on second terminals 106 1-n can be routed by the switchboard device, and internet calls placed on second terminals 106 1-n can be routed by the router and gateway.

Site server 101 and cloud 102 may be connected through any suitable wired (e.g., Ethernet) connection or wireless connection. The wireless connection can be implemented as one or more of a wide-area network (WAN) connection, a local area network (LAN) connection, the Internet, a Bluetooth connection, and/or an infrared connection. Other types of implementations for a wired or wireless connection are possible without deviating from the scope of the present disclosure. At least one data routing device, e.g., a router, and one data control device, e.g., a gateway, may be arranged between site server 101 and cloud 102.

First terminals 105 1-n include any suitable software and hardware capable of receiving phone calls and bi-directionally interact site server 101 through cloud 102. First terminals 105 1-n include one or more of a conventional telephone, a mobile device, a kiosk, a computer, and the like. Cloud 102 and the first terminals 105 1-n may be included entirely or partially in a public switched telephone network (PSTN). Cloud 102 may transmit data to the first terminals 105 1-n via one or more of telephone lines, fiber optic cables, microwave transmission links, cellular networks, communication satellites, undersea telephone cables, and/or any suitable means interconnected by switching centers in the PSTN. Cloud 102 and the first terminals 105 1-n may also be entirely or partially included in a plain old telephone service (POTs). POTs allows analog voice signals to be transmitted from cloud 102 to first terminals 105 1-n through, e.g., telephone cables.

Third party search and analysis engine 107 includes any suitable computer systems capable of performing various authentications and checks. Third party search and analysis engine 107 is connected to site server 101 through cloud 102 such that site server 101 can query third party search and analysis engine 107 through cloud 102 when an identity check, background check, and/or bank information check of a depositor is needed. Third party search and analysis engine 107 is connected to various databases (not shown) such as criminal record database, bank information bases, and databases of other correctional facilities and jails so that the identity/background of a person in interest and related bank information can be verified, upon the query from site server 101. These databases contain various update-to-date information.

Remote server 103 is connected to site server 101, various databases, and service center. Remote server 103 includes any suitable computer systems capable of facilitating bi-directional communication between site server 101 and the databases/RMS service center. Remote server 103 directs queries from site server 101 to suitable databases/RMS service center such that desired information can be obtained by site server 101. Site server 101 further makes a decision based on the obtained information. Information in databases, connected to remote server 103, can also be updated and edited based on commands/signals sent from site server 101. Remote server 103 is connected to site server 101 via suitable wired connection or wireless connection. For example, remote server 103 can be connected to site server 101 via dedicated T1 line and/or T3 line.

Remote server 103 is connected to various databases and service centers that are capable of providing any suitable information inquired by site server 101, such that site server 101 can respond properly to inquiries from inside and outside of the institution. As shown in FIG. 1, remote server 103 is connected to a usage restriction rule database 109, a user database 110, an RMS service center 111, a depositor information database 112, an inmate and criminal record database 113, and an RMS database 114. In various embodiments, site server 101, remote server 103, the described databases, and RMS service center 111, can be implemented in a single device or more than one devices, depending on the design and application requirements. Remote server 103 is connected to site server 101 via suitable wired connection or wireless connection. The wireless connection can be implemented as one or more of a wide-area network (WAN) connection, a local area network (LAN) connection, the Internet, a Bluetooth connection, and/or an infrared connection. Wired connection can be implemented as, for example, dedicated T1 line and/or T3 line.

User database 110 stores financial information of each inmate, in the inmate's user account with system 100. An inmate's user account includes various payment accounts associated with an inmate. For example, a user account can include a Collect Call account, a Prepaid Collect account established by a family or friend or an inmate for collecting calling, a Debit account funded by the inmate, a Commissary account for the purchase of commissary items, and an Inmate Debit account funded and controlled by a family or friend. User database 110 stores account details of each account, such as account balance and details, user information, logs, payment histories, etc. usage restriction rule database stores usage restriction rules to control and manage an Inmate Debit account, i.e., usage restriction rules. Usage restriction rule database is configured to store usage restriction rules provided by system 100 and usage restriction rules customized by a depositor. Accordingly, a depositor who created the Inmate Debit account for an inmate controls and manages the funds in the Inmate Debit account and applies usage restriction rules for how the inmate can use the funds. The inmate, when accessing the funds from a second terminal 106 n, and through site server 101 and remote server 103, can use the funds in the Inmate Debit account according to the depositor's restriction rules. For example, in some embodiments, usage restriction rule database 109 stores a group of restriction rules defined by system, e.g., “only for purchase of snacks” and “only for calling depositor”. In some embodiments, usage restriction rule database 109 provides a plurality of usage restriction rule sets for the depositor to select from and combine. In an example, the depositor is able to select usage restriction rule of a maximum weekly spending amount, e.g., 50 dollars, to be combined with usage restriction rules on certain phone numbers, inmate's mother's home phone number, permitted by the depositor in the second partition of an Inmate Debit account. Accordingly, inmate can only use the second partition of the Inmate Debit account to call his/her mother's home phone number, and the expenses of calling his/her mother's home phone number cannot exceed the weekly maximum of 50 dollars.

RMS database 114 stores a list of accounts with system 100. For example, RMS database 114 stores account information such as the telephone numbers associated with an account so that the telephone numbers are designated as billable numbers, when necessary. RMS database 114 also stores depositor account information, i.e., bank account information linked to a depositor account so that funds transfer between an outside bank of the depositor and an account associated with an inmate can be properly facilitated.

Depositor information database 112 includes various information of depositors associated with inmates. For example, depositor information database 112 includes the phone numbers of depositors, personal information of depositors, contact history, deposit history, and relationship to the inmates. Optionally, personal information of depositors includes names, addresses, relationship to inmates, and registered biometric samples of depositors, which can be used for authenticating identity of the depositors. The biometric samples can be stored in depositor information database 112 or an additional database (not shown).

Inmate and criminal record database 113 includes a list of existing inmates and criminals. The list of existing inmates and criminals includes data collected from various suitable national and/or international facilities. The list of existing inmates and criminals is constantly being updated. For example, inmate and criminal record database 113 stores the names, telephone numbers, registered biometric samples, and personal information of existing inmates and criminals. In response to a query from site server 101, inmate and criminal record database 113 provides appropriate inmate and criminal record information for site server 101 to determine whether a called party or a depositor is linked to the existing inmate and criminal record. Further, site server 101 also updates the depositor information database 112, RMS database 114, and/or user database 110 with information from inmate and criminal record database 113 if a match is found.

RMS service center 111 includes customer service platform configured to provide customer service to a depositor such that RMS service center 111 can assist a depositor with account-related operations such as setting up an account and managing accounts, if desired. RMS service center 111 provides necessary platform for a depositor to access his/her depositor account and make desired management. For example, RMS server center 111 runs backstage programs for websites, interactive voice response (IVR), and live operators for a depositor to access and manage his/her depositor account.

Other databases 115 include any other suitable databases capable of providing other necessary information for the operation of system 100. For example, other databases 115 include databases, e.g., competitive local exchange carrier (CLEC) database, for storing billable status/information associated with a phone number. Other databases 115 also include databases for storing information for authenticating an inmate's identity, e.g., personal information and biometric samples of an inmate. Other suitable databases can also be included.

Site server 101 and/or workstations 108 are installed with user-friendly software, utilizing a graphical user interface (“GUI”) or other types of on-screen display capable device to administrate user accounts of telephone management system. The software allows a system administrator to provide calling restriction rules at all levels of operation. Such restriction rules include, the total number of minutes allowed, the total number of calls placed, dates and times calls are allowed, telephone exchanges allowed to be accessed, the number of times debit inquiry system may be used, and other like restriction rules. Site server 101 can implement the restriction rules based on data provided by remote server 103, if needed.

In an embodiment, site server 101, second terminals 106 1-n, recorder 104, and workstations 108 is partially or entirely included in a telephone management system. Remote server 103, usage restriction rule database, user database 110, RMS service center 111, depositor information database 112, inmate and criminal record database 113, and RMS database 114 is partially or entirely included in a RMS. Telephone management system controls, manages, and monitors any outbound calls, e.g., conventional phone calls and internet calls, to a called party, associated with the phone number and at a first terminal 105 n. In an example, when a calling party initiates a call, before the telephone management system directs the call to the called party, site server 101 queries the RMS to obtain balance information of the calling party. Receiving the query, remote server 103 properly searches one or more of the connected databases for the user account information of the calling party, and returns related account information, e.g., balances of different accounts, of the calling party to site server 101. Site server further determines whether the call can be directed. RMS and telephone management system also determines whether a depositor is eligible to create an account associated with an inmate, and provides assistance to a depositor in managing existing accounts. In another example, when a depositor send an inquiry through the telephone management system, site server 101 directs the depositor's input and suitable commands/signals to remote server 103 such that remote server 103 can query suitable databases and/or RMS service center 111 to return desired information to site server 101. Site server 101 further determines whether the depositor's query can be processed or further searches need to be done through third party search and analysis engine 107.

In an embodiment, a depositor is able to create an Inmate Debit account associated with an inmate through the telephone management system and RMS. An Inmate Debit account includes one or more partitions. The depositor applies usage restriction rules on the partitions to control the usage of the funds by the inmate in each partition. The depositor also has the authority to log into the depositor account to change the usage restriction rules.

To create an Inmate Debit account, a depositor is required to register with system 100. The depositor first sends a registration request to site server 101 through a first terminal 105 n, which includes any suitable hardware having functions of one or more of a website, an IVR, and a live operator assisted deposit. Receiving the request, site server 101 prompts the depositor to provide his/her personal information which can be used to authenticate his/her identity. For example, depositor is prompted to provide social security number (SSN) and/or birthday, relationship to inmate, home address, combined with legal name of the depositor. Optionally, depositor is prompted to provide certain information associated with the inmate in interest as a part of the identity check.

Optionally, a depositor is required to provide one or more biometric samples to be registered with system 100 for the registration. The biometric samples are uniquely associated with the identity of the depositor and can be used to authenticate the identity of the depositor. Optionally, a depositor is required to register his/her biometric samples and personal information at a designated location, e.g., a police station or a registration office, to ensure true identity of the depositor. That is, first terminal 105 n can be located in police station. Biometric samples such as voice sample, fingerprints, facial structure, and retinal scan can be recorded through the first terminal 105 n and sent to site server 101.

After site server 101 receives the input from the depositor, site server 101 directs the input to remote server 103. Site server 101 also directs a command/signal that prompts remote server 103 to search if the input provided by the depositor already exist in depositor information database 112. If the depositor already exists in depositor information database 112, remote server 103 sends a signal to site server 101 indicating the depositor already exists. Site server 101 then prompts the depositor to log in with existing account. If remote server 103 finds no match to the depositor's input, remote server 103 further searches inmate and criminal record database 113 to determine if a match can be found in the existing inmate and criminal record. If a match is found, remote server 103 sends a signal reflecting the status of the depositor and related personal information of the depositor, as stored in inmate and criminal record database 113, to site server 101. Receiving the status of the depositor returned by the remote server 103, site server 101 stops the registration process and sends an alert to workstations 108, such that authorized staff/officers of the institution can act accordingly.

If remote server 103 finds no match in inmate and criminal record database 113, remote server 103 sends a signal to site server 101 indicating no match has been found in inmate and criminal record database 113. Site server 101 further sends a search request to third party search and analysis engine 107 through cloud 102. Receiving the search request from site server 101, third party search and analysis engine 107 starts searching the depositor's identity and background information in other various databases. If no matching criminal/inmate history is found and information provided by the depositor match database records, third party search and analysis engine 107 returns a signal to site server 101 indicating no matching inmate or criminal records are found and the depositor's identity is authenticated, and site server 101 proceeds with subsequent registration process. If a matching inmate/criminal record is found or some information provided by the depositor does not match database records, third party search and analysis engine 107 returns a signal to site server 101 that depositor has inmate/criminal record or has unauthenticated identity, and site server 101 stops the registration process and sends an alert to workstations 108, such that authorized staff/officers of the institution can act accordingly. Optionally, site server 101 sends a signal to the first terminal 105 n to display an error message or a notification message to the depositor when a matching inmate/criminal record is found or some information provided by the depositor does not match database records, and the depositor is given the option to re-enter his/her information. If the search result of third party search and analysis engine 806 authenticates the depositor's identity after he/she re-entering information, alert can be cleared.

When no matching inmate/criminal record is found for the depositor's input and the identity of the depositor is authenticated, site server 101 provides the depositor the option to enter funds related information and sends a command to remote server 103 requesting remote server 103 to store the depositor's input in depositor information database 112, create an Inmate Debit account in RMS database, and link the Inmate Debit account with a user account in user database 110, which is associated with the inmate in interest. The funds related information includes, e.g., bank information, total amount of funds transferred from the bank to the inmate, and any usage restriction rules the depositor applies on the funds.

In an embodiment, remote server 103 stores the inputted personal information and biometric samples of the depositor into depositor information database 112. Each depositor in depositor information database 112 has a unique identity and is associated with a user/an inmate stored in user database 110. In some embodiments, remote server 103 and/or site server 101 periodically compares depositor information in depositor information database 112 with inmate and criminal record database 113 and periodically sends depositor information in depositor information database 112 to third party search and analysis engine 107 for authentication. If a match is found between information of a depositor and an inmate/criminal, an alert and information of the matching depositor are sent to workstations 108.

In an embodiment, site server 101 monitors and tracks account activities in the Inmate Debit account established by the depositor, and generates a profile of the depositor based on the account activity, personal information and background information of the depositor, and certain information of the associated inmate. The profile includes security level, behavioral pattern and financial status of the depositor. For example, site server 101 generates an average range of funds the depositor transfers to the Inmate Debit account. If the a transfer is greatly higher than the range, site server 101 determines the depositor is suspicious and flags the security level of the depositor from “normal” to “abnormal”. Accordingly, site server 101 sends an alert to workstations 108. Thus, information about depositors can be collected by system 100 and security of the institution can be improved.

Optionally, when no matching inmate/criminal record is found for the depositor's input, site server 101 directs the depositor's input to workstations 108 with a request for the inmate's confirmation. Authorized staff/officers, receiving the request, can obtain a confirmation from the inmate and reply to the request. In an example, authorized staff/officer can verify the depositor's inputted personal information and relationship with the inmate to confirm the request.

In various embodiments, the searching process, i.e., through remote server 103 and/or third party search and analysis engine 107, and the confirmation process can be immediate or may have delays. That is, a depositor's registration request can be processed immediately or can be paused for a certain amount of time. The specific time for a searching process should be subjected to different design and/or application requirements.

Further, remote server 103 creates an Inmate Debit account in RMS database 114 associated with the depositor. The Inmate Debit account includes the bank account information of the depositor, information of the funds sent by the depositor, and other billable means, e.g., telephone number, of the depositor. Each depositor is stored with a unique identifier, such as the SSN of the depositor, so that the depositors can be uniquely located. Each depositor is also stored to be associated with the inmate in interest. If the depositor is associated with more than one inmates, user accounts associated with the inmates in interest are linked to the depositor's account. A log of account activity in a depositor account, e.g., funds transfer and account balance for each inmate, can be generated by RMS database 114.

In various embodiments, when a depositor enters bank information, site server 101 sends the bank information to third party search and analysis engine 107 to verify whether the bank is connected to any suspicious activity. When the bank information is authenticated, site server 101 receives a confirmation signal from third party search and analysis engine 107 and further allows funds transfer from the bank. In some embodiments, RMS defines different limits on funds transfers. If RMS receives a large amount of funds, exceeding a fund transfer limit, RMS sends an alert to workstations 108 and freezes the funds. If the funds transfer frequency is too high for an inmate, in a specific period, an alert is sent to workstations 108 and funds are frozen. Funds are clarified after institution obtains confirmation or proof from depositors and inmates.

Site server 101 further allows the depositor to create partitions in an Inmate Debit account and apply usage restriction rules on the partitions. The usage restriction rules can be stored in RMS database 114 and/or usage restriction rule database. Usage restriction rules applied on a partition includes, but are not limited to, setting a maximum amount or percentage that can be used, limiting the maximum number of called parties the inmate can contact, restricting the phone numbers that can be called, restricting the types of purchases, limiting funds transfer between accounts, etc. With the usage restriction rules applied on partitions, a depositor can control the amount of funds the inmate uses and how the funds are used. A depositor has the option to create different authority levels in different accounts. For example, a depositor can create two partitions in an Inmate Debit account set up for an inmate. The first partition is set to be only used to pay for the calls the inmate makes to the depositor, and the second partition is used for commissary expenses. The depositor has the authority level to set the first partition to be used for “calls to depositor only”, and forbids the inmate to use funds in the first partition in other ways. The depositor has the authority to combine different usage restriction rules and customize usage restriction rules. The depositor also has the authority to allow the inmate to use the funds in the second partition in any desired ways. A depositor can set funds transfer to the Inmate Debit account to be manually or automatically. In various embodiments, system 100 determines a maximum amount of funds transfer into a payment account and the depositor should not violate any funds transfer/usage restriction rules and limits set by system 100.

In one embodiment, the maximum number of partitions applied with different usage restriction rules is determined by system 100. In another embodiment, a depositor is able to create a desired number of partitions in an Inmate Debit account. A depositor has the authority to combine different usage restriction rules to be applied on a partition. For example, a depositor can set the first partition to have a daily maximum spending of $20 and the funds can only be used for buying books. A depositor can also set the second partition to have a weekly maximum spending of $100 and the funds can only be used for calling depositor and buying snacks. Depending on different applications, the number and combination of usage restriction rules applied on each partition can be customized based on depositor's preferences. Through site server 101, a depositor can log into his/her account and determine the balance in each partition, and manage the usage restriction rules in partitions, if desired.

A depositor can manage created Inmate Debit account and customize usage restriction rules on a first terminal 105 n. The depositor is able to access his/her depositor account and the created Inmate Debit account through a website, an IVR, and/or a live operator assisted deposit service, through the first terminal 105 n. The website, IVR, and live operator are connected to the depositor via site server 101 and remote server 103 so that any input by the depositor is check according to the authentication process described previously. To manage account, the depositor is first required to provide necessary information to authenticate his/her identity. After logging into his/her depositor account, the depositor is able to manage the funds and usage restriction rules in the partitions online or with the help of a live operator.

When an Inmate Debit account is created, site server 101 and remote server 103 also updates the account information and funds information in the corresponding inmate's user account, in user database 110. Accordingly, user database 110 stores information of different payment accounts associated with each inmate. An inmate's user account includes a summary of all payment accounts and account details of each payment account. An inmate is able to access account information through site server 101 and remote server 103 to check balance and manage funds in different payment accounts. For example, an inmate is allowed to transfer funds between partitions in his/her Inmate Debit account, and from a partition in his/her Inmate Debit account to his/her Commissary account, and is allowed to transfer funds in his/her Debit account to a restricted partition in his/her Inmate Debit account. The account information of each user is uniquely associated with the identity of the user and a unique identifier is used to link all the payment accounts to the user.

In an embodiment, a depositor, family of an inmate, registers his/her personal information and biometric samples through a first terminal 105 n, a kiosk, at a police station, for an Inmate Debit account. Fingerprints and voice samples are recorded by the kiosk 105 n and sent to site server 101. The depositor is also prompted to provide his/her SSN, legal name, home address, and relationship to the inmate. Site server 101 further sends the depositor's personal information and biometric samples, and a command to remote server 103 such that remote server 103 starts searching in depositor information database 112 to determine if a match can be found. When no match is found in depositor information database 112, site server 101 sends a signal to remote server 103 such that remote server 103 starts searching in inmate and criminal record database 113 to determine if a match can be found. When no match is found in inmate and criminal record database 113, site server 101 sends the depositor's personal information and biometric samples, and a command to third party search and analysis engine 107 such that third party search and analysis engine 107 starts searching in other databases to determine a matching inmate/criminal record can be found and if the depositor's identity, including relationship to the inmate, can be authenticated. Third party search and analysis engine 107 finds no match of inmate/criminal record for the depositor and the personal information is consistent with database records, third party search and analysis engine 107 then returns a signal to site server 101 indicating no inmate/criminal records have been found for the depositor and depositor's identity information matches database records. Accordingly, site server 101 sends a confirmation request to workstations 108, requesting a confirmation from the inmate in interest. The inmate is asked about the home address and relationship to the depositor to verify the depositor's identity. Upon a confirmation from the inmate, site server 101 determines the depositor's identity is authenticated and sends a signal to remote server 103 to allow remote server 103 to create an Inmate Debit account in RMS database 114 and sends a signal to kiosk 105 n to allow the depositor to enter bank information. Further, receiving the bank information, site server 101 sends the bank information and the depositor's personal information to third party search and analysis engine 107 to verify the validity of the bank.

After the validity of the bank is confirmed by the third party search and analysis engine 107, site server 101 sends a command to remote server 103 such that remote server 103 adds bank information into the newly-created Inmate Debit account in RMS database 114. Site server 101 further allows depositor to create partitions in the Inmate Debit account and customized usage restriction rules on the partitions. For example, the depositor deposits a total amount of 100 dollars into the Inmate Debit account, creates three partitions in the account, and applies usage restriction rules on partitions 2 and 3. The first partition has a deposit of 40 dollars, the second partition has a deposit of 20 dollars, and the third partition has a deposit of 40 dollars. The depositor defines the first partition to be a “free” account, i.e., the inmate is able to use the funds freely as he/she desires. The depositor defines the second partition to have a maximum daily spending of 20 dollars, and the inmate can spend the funds only on food and books. The depositor defines the third partition to be a call payment account, the inmate can only use the funds in the third partition to call the depositor's cell phone number and inmate's daughter's cell phone number, and the partition has a maximum daily spending of 15 dollars. The depositor defines that if the funds in any partition is below 5 dollars, funds of 20 dollars is transferred from the registered bank of the depositor to the partition. The depositor defines that the depositor has the authority to add any reasonable amount of funds, lower than the maximum amount limited by system 100, into a partition. The depositor also defines the Inmate Debit account to generate a monthly transaction report, reflecting the inmate's usage of each partition in the Inmate Debit account, to the depositor. The report also includes detailed information on each usage and balance of each partition.

In some embodiments, the depositor has the option to speak with a live operator. The depositor is given the option to send a request for live operator service through first terminal 105 n. After site server 101 receives the request, site server 101 prompts remote server 103 to connect live operator service provided by RMS service center 111 so that live operator and depositor can be connected.

In some embodiments, the depositor sets up and manages account through an IVR service. The depositor's selections and inquiries are extracted through the voice recognition functions of the IVR service. Site server 101 and remote server 103 further respond to the depositor's selections and inquiries, and return appropriated information to the depositor through the IVR service.

In various embodiments, site server 101 and remote server 103 receive the depositor's input through websites, IVR services, and live operator services. The received depositor's input are converted into corresponding commands and account data for setting up an Inmate Debit account and managing the Inmate Debit account. For example, a depositor is provided the option to determine the number of partitions, the funds in each partition, and any usage restriction rules to be applied in desired partitions.

Further, after the funds transfer and management are received by site server 101 and remote server 103, funds information associated with the inmate is also added/updated into the user/inmate's user account in user database 110. Inmate's ID number is used to link all the payment accounts associated with the inmate. The inmate has the authority to view all payment accounts and manage certain payment accounts, depending on the usage restriction rules applied on the partitions.

When the inmate desires to make a call to a called party, the inmate is given the options of choosing a payment account to pay for the call or to bill the called party, on a second terminal 106 n, a conventional telephone. In one embodiment, inmate chooses to pay for the call from the “free” first partition of his/her Inmate Debit account. After the inmate selects the first partition on the conventional phone 106 n, site server 101 sends a command to remote server 103 to check the balance of the first partition of the inmate's Inmate Debit account, in user database 110, to determine whether the first partition is billable. Remote server 103 further sends a signal to RMS database 114 and/or user database 110 to check whether first partition has sufficient funds for the call. If first partition has sufficient funds, remote server 103 sends a signal to site server 101 to confirm that the first partition is billable, and site server 101 directs the call. If first partition doesn't have sufficient funds, remote server 103 searches the account balances in other payment accounts associated with the inmate in user database 110. Remote server 103 further returns the search result, reflecting the insufficient funds information for the first partition and other billable payment accounts to site server 101. Site server 101 then informs the inmate that first partition doesn't have sufficient funds and provides the inmate the options to choose another billable payment account to pay for the call. The inmate can decide accordingly. If the search result of remote server 103 returns that no other billable payment account, site server 101 informs the inmate that the inmate doesn't have sufficient funds in any payment account and provides him/her the option to end the call or refill a payment account to pay for the call.

In various embodiments, remote server 103 only returns payment accounts and partitions that are billable for a call. For example, if a partition in the Inmate Debit account has sufficient funds but is restricted from being used for pay for calls to the dialed phone number, remote server 103 does not return the partition as a billable partition to site server 101. In some embodiments, if the partition is not directly billable for a dialed phone number but funds in the partition can be transferred to a billable payment account for the dialed phone number, remote server 103 returns the partition to site server 101 and informs site server 101 the status of the partition. Site server 101 then provides the inmate the option to transfer funds from the partition to other payment accounts.

If the inmate dials a phone number and does not choose any payment methods, site server 101, before directing the call, sends a command to remote server 103 such that remote server 103 searches RMS database 114 to check whether the phone number is linked to a billable depositor account in RMS database 114. If a match is found, remote server 103 sends a signal to site server 101 such that site server 101 informs the inmate, through the conventional telephone 106 n, that the phone number is associated with a depositor account, e.g., a Prepaid Collect account, and provides the inmate the option to pay for the call using the Prepaid Collect account. If the inmate declines, site server 101 sends a command to remote server 103 such that remote server 103 searches in user database 110 to locate any other billable payment accounts associated with the inmate. Remote server 103 then returns the search result to site server 101 and site server 101 informs the inmate all billable payment accounts. The inmate then selects a payment account to pay for the call and site server 101 directs the call to a desired first terminal 105 n associated with the phone number. If the inmate declines, site server 101 provides him/her the option to end the call or refill a payment account to pay for the call. In an example, the phone number is associated with the depositor that created the partitions in the inmate's Inmate Debit account Site server 101 returns the Prepaid Collect account associated with the depositor, and the first partition and third partition of the Inmate Debit account as billable payment accounts, to the inmate. If the phone number is associated with a called party not permitted to call using the third partition, site server 101 returns the Prepaid Collect account and the first partition of the Inmate Debit account as billable payment accounts.

In various embodiments, if remote server 103 finds no matching account to the phone number in RMS database 114 and user database 110, site server 101 sends a command to remote server 103 such that remote server 103 searches other databases 115. If a match is found, remote server 103 returns the search result and site server 101 provides inmate the option to pay for the call using the payment methods found in other databases 115. If no match is found in any of RMS database 114, user database 110, and other databases 115, remote server 103 returns the search result to site server 101, and site server 101 provides the inmate the option to end the call or refill a payment account to pay for the call. It should be known to those skilled in the art that, the order to search for a matching account in different databases is subjected to different application and design requirements, and should not be limited by the embodiments of the present disclosure.

In an example, inmate is able to access his/her user account information through a second terminal 106 n and manage available accounts. When an inmate requests to access his/her account, site server 101 sends a command and certain personal information of the inmate to remote server 103 such that remote server 103 locates the user account associated with the identity of the inmate, and returns the account information to site server 101. Site server 101 further displays the returned account information to inmate. For example, the second terminal 106 n can include a kiosk having a card reader and a screen. An inmate is able to authenticate his/her identity through the kiosk 106 n by inserting a badge/card having the inmate's personal information and bank information, and providing certain personal information to the kiosk 106 n. In some embodiments, the inmate is prompted to provide biometric input for identity authentication.

After the inmate access his/her user account, the inmate has the authority to transfer funds from/to a “free” partition, or from/to certain partitions, i.e., partitions not restricted from transferring outbound funds. Accordingly, funds can be transferred from the Inmate Debit account to certain payment accounts, in some embodiments. That is, the inmate is able to refill desired payment accounts using the Inmate Debit account. The inmate is also allowed to call different called parties using the first partition of the Inmate Debit account, or call a certain called party, permitted by the third partition of the Inmate Debit account.

In various embodiments, a family member or a friend of the inmate, after identity authentication and background check, is eligible to create an Inmate Debit account associated with the inmate. In some embodiments, institution has the authority to limit the relationship between a depositor and the inmate, e.g., to improve security or for other reasons. For example, institution has the authority to allow only parents, spouse, and children or an inmate can create an Inmate Debit account associated with the inmate.

### Depositor Account and Inmate Debit Account

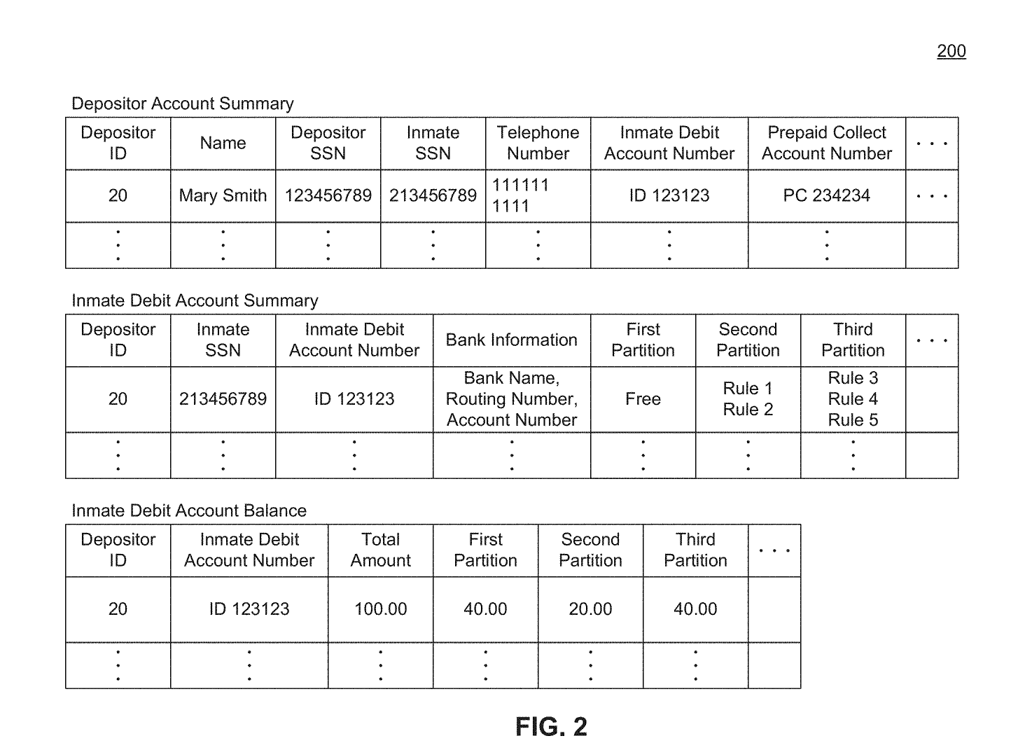

FIG. 2 illustrates database tables 200 stored in RMS database, according to embodiments of the present disclosure. In an embodiment, database tables 200 provide billable information associated with a depositor or a the depositor's phone number. Database tables 200 include a depositor account summary table, an Inmate Debit Account Summary table, and an Inmate Debit Account Balance table. In an embodiment, Depositor Account Summary table provides billable information associated with a depositor and the depositor's phone number, Inmate Debit Account Summary table provides the Inmate Debit account associated with or created by the depositor and partition usage restriction rules of the Inmate Debit account, and Inmate Debit Account Balance table provides the balance information for each partition. Suitable data structures, e.g., pointers, and data storage are used to properly link the tables uniquely to the depositor. Certain information in the tables is uniquely associated with the inmate in interest and can be used as identifiers to link database tables.

Depositor Account Summary table identifies a depositor and links the depositor to an inmate. Depositor Account Summary table also identifies all the payment accounts associated with the depositor and the depositor's phone number. For example, as shown in the Depositor Account Summary table, a depositor, having a depositor ID of “20”, SSN of “123456789”, and legal name “Mary Smith”, has a telephone number “1111111111”. The depositor created an Inmate Debit account “ID123123” and a Prepaid Collect account “PC234234” for an inmate that has an SSN of “213456789”. The depositor “Mary Smith” and depositor's phone number “1111111111” are uniquely linked to the Inmate Debit account “ID123123” and the Prepaid Collect account “PC234234”.

Inmate Debit Account Summary table includes certain information of the Inmate Debit account created by the depositor. For example, as shown in the Inmate Debit Account Summary table, the Inmate Debit Account Summary table associated with depositor “Mary Smith” includes the Inmate Debit account “ID123123”, the information of the bank associated with the Inmate Debit account, and usage restriction rules defined in each partition of the Inmate Debit account. For example, depositor “Mary Smith” creates an Inmate Debit account and divides the Inmate Debit account into three partitions, i.e., first partition, second partition, and third partition. First partition is defined to be a “free” partition, and no usage restriction rules are applied on first partition. That is, without violating any funds transfer rules set by the institution, the inmate in interest, i.e., inmate with SSN “213456789”, is free to use the funds in the first partition as he/she desires. He/she can also transfer funds between the first partition and another desired payment account. Depositor “Mary Smith” applies rule 1 and rule 2 on the second partition. In an example, rule 1 limits a maximum daily spending of 20 dollars, and rule 2 limits the inmate to spend the funds only on food and books. Depositor “Mary” applies rules, 3, 4, and 5 on the third partition, In an example, rule 3 limits the inmate to use the funds only to call the depositor's cell phone number, rule 4 limits the inmate to use the funds only to call the inmate's daughter's cell phone number, and rule 5 limits a maximum daily spending of 15 dollars.

Inmate Debit Account Balance table includes the Inmate Debit account “ID123123”, the total amount of funds in the Inmate Debit account, and the balance of each partition. For example, as shown in the Inmate Debit Account Balance table, Inmate Debit account “ID123123” has a total amount of 100 dollars, where the first partition is deposited with 40 dollars, the second partition is deposited with 20 dollars, and the third partition is deposited with 40 dollars.

Certain information in the Inmate Debit Account Summary table and the Inmate Debit Account Balance table is properly linked to the inmate's user account through any suitable data structures and algorithms. The inmate is then able to view funds and usage restriction rules in the payment accounts, and manage funds, if needed.

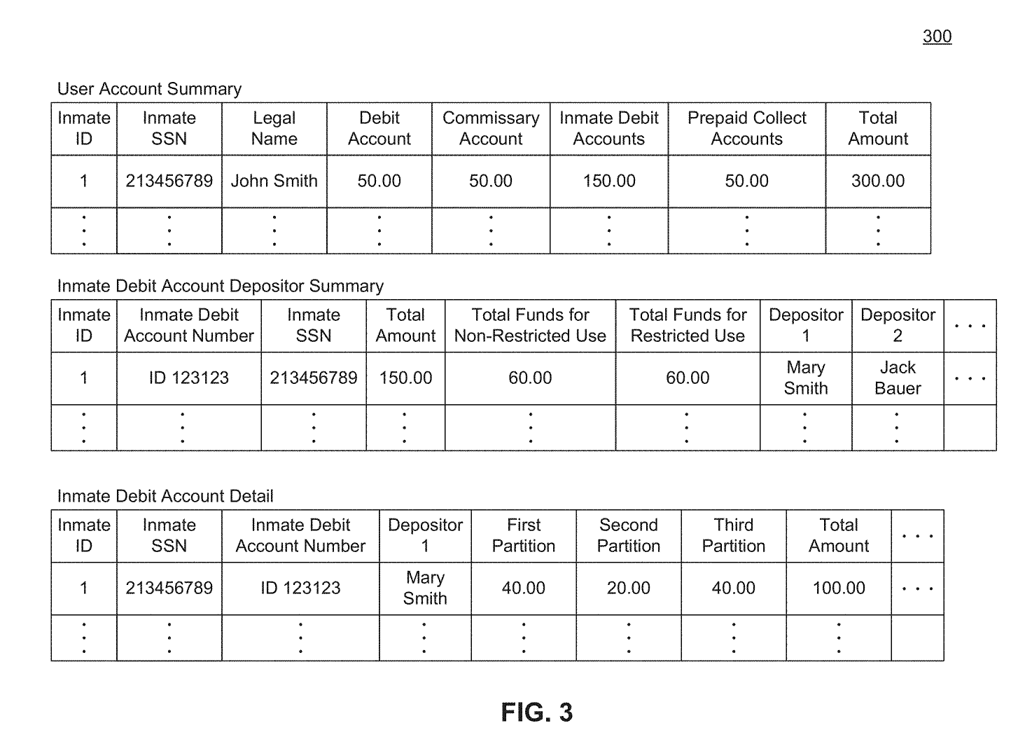

FIG. 3 illustrates database tables 300 stored in user database, according to embodiments of the present disclosure. In an embodiment, database tables 300 provide information of different payment accounts in the inmate's user account. Database tables 300 include a User Account Summary table, an Inmate Debit Account Summary table, and an Inmate Debit Account Detail table. The User Account Summary table provides information of different payment accounts associated with the inmate. Inmate Debit Account Summary table includes information of the inmate's Inmate Debit accounts. Inmate Debit Account Detail table includes information of each Inmate Debit account and the account details.

User Account Summary table provides a summary of different payment accounts associated with an inmate. For example, as shown in the User Account Summary table, inmate having a legal name “John Smith”, SSN “213456789”, and inmate ID “1”, is associated with depositor “Mary Smith” through a unique identifier, e.g., SSN. Inmate “John Smith” has a Debit account, a Commissary account, Inmate Debit accounts, and Prepaid Collect accounts. The payment accounts have a balance of 50 dollars, 50 dollars, 150 dollars, and 50 dollars, respectively, and have a total balance of 300 dollars.

Inmate Debit Account Summary table includes information of the inmate's Inmate Debit accounts. As shown in the Inmate Debit Account Depositor Summary table, inmate “John Smith” has a total balance of 150 dollars in his Inmate Debit account. The 150 dollar is deposited by two depositors, i.e., depositor 1 “Mary Smith” and depositor 2 “Jack Bauer”. The total funds for non-restricted, i.e., “free”, usage is 60 dollars, and the total funds for restricted usage is 90 dollars. The total funds for non-restricted use includes a sum of funds in all “free” partitions by all depositors. The total funds for restricted use includes a sum of funds in all “restricted” partitions by all depositors.

Inmate Debit Account Detail table includes detailed information of each partition created by each depositor. For example, as shown in the Inmate Debit Account Detail table, inmate “John Smith” has a depositor “Mary Smith”, who deposited a total amount of 100 dollars into the Inmate Debit account of inmate “John Smith”. Depositor “Mary Smith” created three partitions, i.e., first partition, second partition, and third partition, each having a balance of 40 dollars, 20 dollars, and 40 dollars, respectively. Each partition is properly associated with the depositor's account and the respective usage restriction rules applied on the partition. When the inmate is accessing his/her Inmate Debit account, the inmate is informed by system 100 the usage restriction rules applied on each partition. For illustrative purposes, only Inmate Debit Account Detail table created by depositor “Mary Smith” is shown.

In an embodiment, depositor “Mary Smith” creates an Inmate Debit account for inmate “John Smith” and deposits 100 dollars into the Inmate Debit account. Depositor “Mary Smith” divides the Inmate Debit account into three partitions and applied usage restriction rules on the second partition and the third partition, as previously described. Accordingly, site server 101 and remote server 103 adds information of the Inmate Debit account into the depositor account associated with “Mary Smith”, in RMS database 114, and updates the information of Inmate Debit account, established by depositor “Mary Smith”, in the user account of inmate “John Smith”, in user database 110. The depositor and the Inmate Debit account are uniquely linked to the user account of inmate “John Smith” through the SSN of “John Smith”. The account information Inmate Debit account established by depositor “Mary Smith” is then properly stored into the inmate's user account. In addition to depositor “Mary Smith”, inmate “John Smith” has another Inmate Debit account created by depositor “Jack Bauer”. Information of the Inmate Debit accounts created by the two depositors are properly analyzed, stored, and linked to the usage restriction rules, if needed.

When inmate “John Smith” requests access of his user account from second terminal 106 n, a kiosk, site server 101 receives the request to access payment accounts associated with “John Smith” and sends remote server 103 a command to fetch information of different payment accounts from user database 110. Receiving the search result from remote server 103, site server 101 displays a summary of balances in different payment accounts, e.g., Debit account, Commissary account, Inmate Debit accounts, and Prepaid Collect accounts, to inmate “John Smith”, on the kiosk 105 n. Inmate “John Smith” then properly selects the Inmate Debit accounts to display total available funds. In response to the selection, site server 101 and remote server 103 properly display the total restricted funds and non-restricted funds in the Inmate Debit accounts, on the kiosk 105 n. Inmate “John Smith” then selects the Inmate Debit account created by depositor “Mary Smith”. Site server 101 and remote server 103 then properly displays the balances in the partitions and the usage restriction rules for the partitions. For example, kiosk 105 n can display “Balance of first partition: 40 dollars. This is a free account”, and “Balance of second partition: 20 dollars. This account is only used for purchase of books and food and has a daily maximum of 20 dollars”, or the like. Inmate then manages/uses funds based on the usage restriction rules.

In various embodiments, the Inmate Debit account is merged with or is included in the Debit account, being associated with the same inmate. That is, the partitions created in the Inmate Debit account are partitions in the Debit account and the usage restriction rules still apply. Suitable data structures are used to connect database tables such that the partitions and the usage restriction rules are shown in the inmate's Debit account.

In various embodiments, workstations 108 are able to access desired databases through site server 101 and remote server 103 to monitor activities of inmate's user accounts and depositor accounts. Certain data in the desired databases, e.g., user database 110, depositor information database 112, RMS database 114, and other databases 115 are inquired by workstations 108 and returned by remote server 103. Site server 101 and/or remote server 103 process the inquired data to generate reports or graphs that reflect, e.g., account activity of an inmate, behavioral pattern of the depositors, relationship between the depositors and the inmate, and financial information of the inmate and depositors. Institute is able to make decisions based on the data.

It is apparent to those skilled in the art that, the database tables shown in the present disclosure are only exemplary. Account information associated with a depositor account and/or a user account can be stored in any suitable forms and data structures that can be properly linked to the depositor and/or inmate. The specific forms of data storage/structures should not be limited by the embodiments of the present disclosure.

### Site Server and Remote Server

Site server 101 and remote server 103 are each configured to receive data, process data, and make decisions based on the processing results. In an embodiment, site server 101 and remote server 103 include communication server 401, database server 402, analysis server 403, biometric server 404, support server 405, and database 406, all of which are connected to each other via a network bus 407. In some embodiments, site server 101 and remote server 103 each has servers 401-405. In some other embodiments, site server 101 and remote server 103 share servers 401-405. In some other embodiments, the functions of communication server 401, database server 402, analysis server 403, biometric server 404, support server 405, and database 406 are implemented within a single device. Each of the servers 401-405 can be constructed as individual physical hardware devices, or as virtual servers. The number of physical hardware machines can be scaled to match the number of simultaneous user connections desired to be supported by system 100. For site server 101, database 406 includes any suitable database for storing data received from third party search and analysis engine 107 and remote server 103. For remote server 103, database 406 includes various databases 110, 112, 113, 114, and 115. Additional databases are also included in database 406 to facilitate proper functions of site server 101 and remote server 103.

In an embodiment, communication server 401 consists of one or more servers, and is configured to receive and transmit information to/from one or more authorized facilities such as site server 101 and various databases 110, 115, 112, 113, and 114. Communication server 401 of site server 101 receives input from depositors and inmates and send the processed input, with request/commands to remote server 103 or third party search and analysis engine 107. Communication server 101 of site server 101 also receives search/processing results from third party search and analysis engine 107 and remote server 103 and sends responses to the depositors and inmates. Communication server 401 of remote server 103 receives commands/queries from site server 101 and returns search/processing results to site server 101. That is, communication servers 401 forward inquiries to respective analysis server 403 through network bus 407 for analysis of and generation of a response to the inquiry. Communication servers 401 further receive the response from analysis server 403 and forward the response to the appropriate party.

In an embodiment, communication server 401 is further configured to perform authentication of inquiries to determine whether the submitting facility or party is authorized to access the information located in database 406. If the facility or party is authenticated, communication server 401 continues with the inquiry process by, for example, forwarding the inquiry to analysis server 403. Moreover, communication server 401 is further configured to encrypt and decrypt all communications transmitted and received by system 100 for security purposes. In an embodiment, a facility/party is authorized only to write data into database 406, only to read data from database 406, or authorized to both read data from and write data into database 406. In another embodiment, communication server 401 is configured to provide different levels of access to database 406 based on the type of facility and the type of party. Moreover, access to data within database 406 may vary based on the type of data to which access is sought. For example, one facility can be authorized only to access certain types of data into database 406, such as the data that the facility has uploaded. Another facility can be authorized to access its data as well as data provide by other facilities. The access by facilities can be limited to read only, write only, or read/write based on the type of facility, the type of data, or any other parameters related to system 100. For example, communication server 401 may be configured to allow read/write access to institution but only read access to third party search engine 107.

In an embodiment, database server 402 consists of one or more servers, and is configured to store and organize data in database 406. Database server 402 can be configured to run a database management system, such as MYSQL™. Database server 402 interfaces with database 406 to store information provided to system 100 by connected facilities such as first terminals 105 1-n, third party search and analysis engine 107, and second terminals 106 1-n. For site server 101, such information includes third party search result and remote center search result. For remote server 103, such information includes depositor's personal information, biometric samples, depositor's account information, third party search result, inmate's personal information, and inmate's account information. Database server 402 can further be configured to provide information from database 406 to connected facilities who submit inquiries. Moreover, database server 402 is configured to encrypt the information prior to storage to ensure security of the information.

In an embodiment, analysis server 403 consists of one or more servers, and functions as the primary logic processing center in site server 101 and remote server 103, respectively. For site server 101, analysis server 403 processes information input from inmates, depositors, third party search and analysis engine 107, and remote server 103, makes decisions based on the information input, and responds correspondingly. For remote server 103, analysis server 403 processes queries and commands sent by site server 101, fetches and/or updates proper data, and returns the search result to site server 101. As part of its functionality to conduct analysis of inquiries based on data in database 406, analysis server 403 can further be configured to manage and facilitate communication between communication server 401, database server 402, biometric server 404, support server 405, and database 406.

In various embodiments, analysis servers 403 also generate logs and reports reflecting histories of account activities associated with an inmate. The logs and reports may include analytical reports and visual representations of an inmate's account information such as charts illustrating an inmate's account balances and graphs illustrating connections/relationship between an inmate and other parties or inmates. Because analysis servers 403 have access to database 406, which provides data storage of inmates, depositors, and other parties from across multiple sources, analysis servers 403 are capable of detecting connections and revealing patterns between multiple parties and inmates.

In an embodiment, biometric server 404 consists one or more servers, and is configured to process and/or store biometric data of inmates and depositors. Biometric data can include any information regarding an inmate's or a depositor's appearance, physical characteristics, or other identifying traits that may be unique to the inmate such as voice data, facial recognition data (2D or 3D), handwriting samples, and fingerprint data. Biometric server 404 is configured to assist in analyzing biometric input sent from depositors via first terminals 105 1-n and inmate via second terminals 106 1-n. For example, biometric server 404 can compare received biometric input against stored biometric data.

In an embodiment, support server 405 consists of one or more servers, and is configured to facilitate real-time services, e.g., websites, IVR, and live operators, for establishing and managing depositor account for a depositor. Support server 405 is able to direct depositor's inquiries and commands to the real-time service operated on the RMS service center 111 such that RMS service center provides corresponding responses to depositor's inquiries and commands through support server 405. Support server 405 includes necessary hardware and/or software to extract information from a depositor's selection/inquiry and return responses, as a result of the selection, to the depositor. For example, support server 405 can include a large vocabulary voice recognition application/system, an agent/operator management application, and a data interface. Support server 405 also buffers or stores suitable data based on the user's selection, and transmits certain data to certain other servers for processing or storage. For example, support server 405 is able to extract a depositor's commands on the amount of funds and the number of partitions he/she desires to setup through the data interface, e.g., connections or transmission means, of an IVR service. Support server 405 further sends the extracted information to the database server 402 for storage and to the analysis server 403 to be processed. Appropriate response is generated by the analysis server 403 and is transmitted to the depositor through the data interface.

In an embodiment, database 406 provides access to all inmate information and depositor information available to system 100. In general, database 406 stores any data stored by communication server 401, database server 402, analysis server 403, and biometric server 404. Because the data stored on database 406 may consume a significant amounts of storage space, database 406 may include a Network Attached Storage (NAS) device, which is configured as a mass storage device, or configured as a storage area network (SAN) comprising multiple storage devices. In order to reduce the required size, database 406 preferably includes a backup routine to transfer data to permanent storage devices, such as archival permanent storage or optical disks, after a predetermined time has elapsed since the initial recording of that data. Database 406 is connected to communication server 401, database server 402, analysis server 403, biometric server 404, and support server 405 by way of the network bus 407.

### System Operations

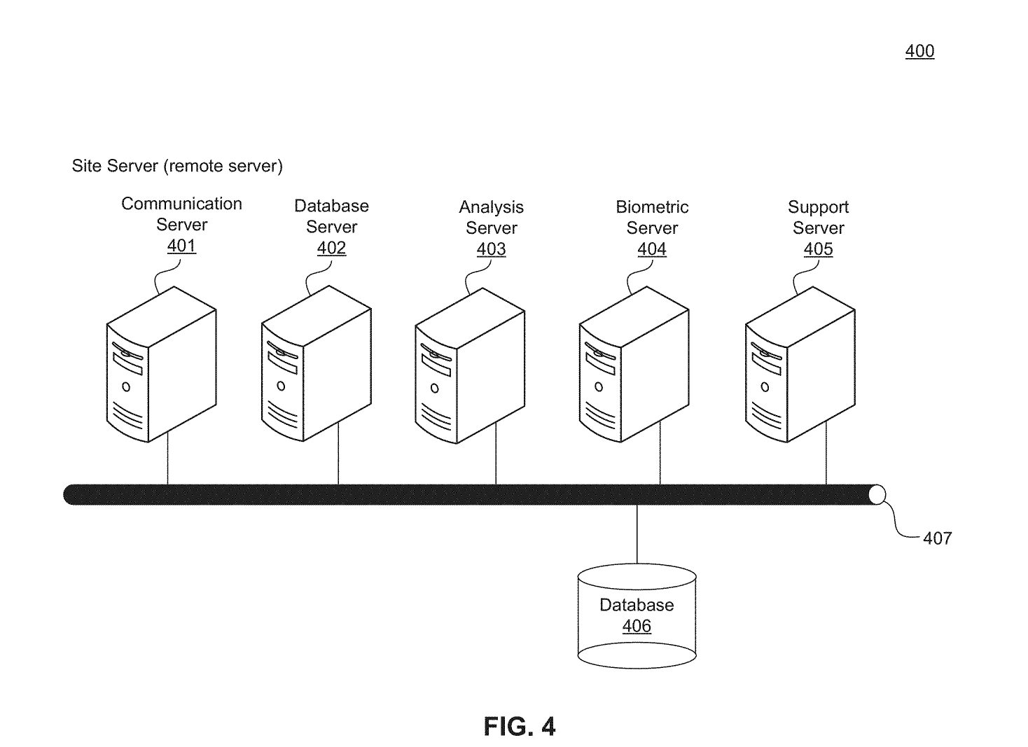

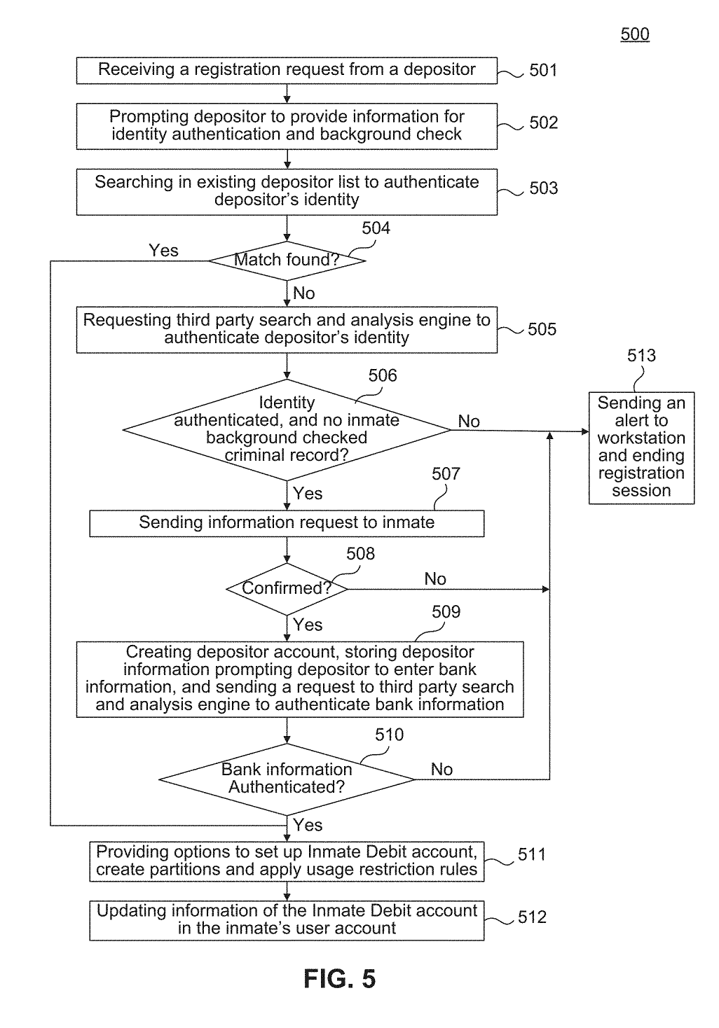

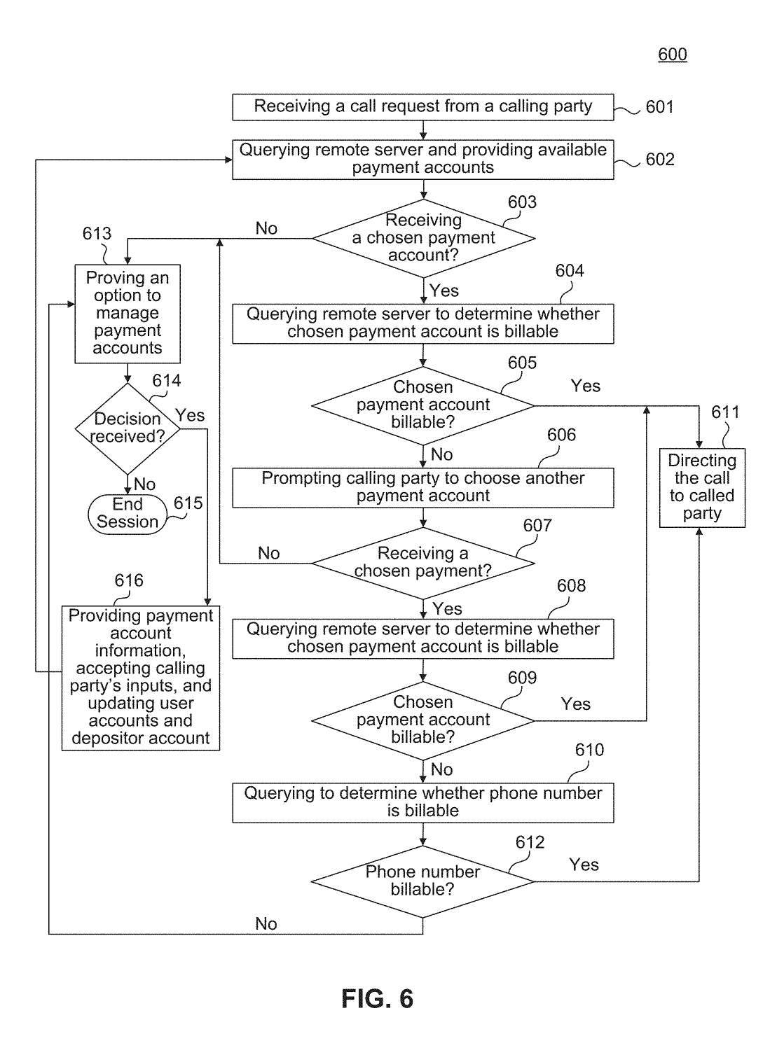

Operations of creating and managing Inmate Debit account and choosing funds in a payment account to pay for calls and other activities using system 100 will be described with respect to FIGS. 5, 6, and 7. Although the physical devices and components that form the system have largely already been described, additional details regarding their operations will be described below with respect to FIGS. 1-4. While FIGS. 5, 6, and 7 contain methods of operation of system 100, the operations are not limited to the order described below, and various operations can be performed in a different order. Further, two or more operations of each method can be performed simultaneously with each other.

FIG. 5 illustrates an exemplary process flow 500 of a depositor creating and managing an Inmate Debit account, according to the embodiments of the present disclosure.

In step 501, site server receives a registration request from a depositor. Receiving the registration request, In step 502, site server prompts depositor to provide certain information for identity identification and background check. Receiving depositor's input information, in step 503, site server sends a command and depositor's input information to remote server to request searching existing depositor list to authenticate the depositor's identity. Receiving the command, remote server queries depositor information database, RMS database, user database, inmate and criminal record database, and other databases to search for a match to depositor's input information. Remote server further returns search result to site server. Site server then decides, in step 504, if a match is found, process proceeds to step 511; if no match is found, process proceeds to step 505. In step 505, site server sends a request and depositor's input information to third party search and analysis engine to authenticate depositor's identity and inmate/criminal record. Receiving the request from site server, third party search and analysis engine searches suitable databases and returns search result to site server. Site server then decides, in step 506, if search result returned by third party search and analysis engine show depositor's identity is authenticated, background is checked, and no inmate/criminal record has found, process proceeds to step 507; if depositor's identity cannot be authenticated or inmate/criminal record is found, process proceeds to step 513.

In step 507, site server sends a confirmation request to the inmate in interest through workstations and prompts the inmate to confirm identity of and relationship with the depositor. Site server then decides, in step 508, if the inmate confirms, process proceeds to step 509; if the inmate is not able to confirm, process proceeds to step 513. Receiving the inmate's confirmation, in step 509, site server sends a command to remote server to create a depositor account, stores depositor information, prompts depositor to enter bank information, and sends a request to third party search and analysis engine, together with the bank information and related personal information of depositor, for authentication. Site server then determines, in step 510, if the bank information is authenticated, process proceeds to step 511; if the bank information cannot be authenticated, process proceeds to step 513. After the bank information is authenticated, in step 511, site server provides provider the options to set up an Inmate Debit account, create partitions in the account, and apply usage restriction rules. Further, in step 512, site server sends a command to remote server to update user account information of the inmate, i.e., to add the Inmate Debit account information into the inmate's user account. In step 513, site server sends an alert to the workstations of the institute and ends the registration session.

In various embodiments, when a depositor, already registered with system 100, desires to manage his/her user account, depositor can log into his/her depositor account through a first terminal, e.g., a computer or a mobile device, and manage the partitions. The log in process includes entering certain personal information and biometric input. In one embodiment, if a depositor's attempts to log into the depositor account fail a certain number of times, depositor account is locked up and site server sends an alert to workstations. To re-log in, depositor needs to re-register or contact RMS service center 111 to authenticate his/her identity.

FIG. 600 illustrates a process 600 of an inmate choosing a billable payment account for a call, according to the embodiments of the present disclosure.

In step 601, site server receives a call request from a calling party, i.e., an inmate. Receiving the call request, in step 602, site server queries remote server for available billable payment accounts and provides the returned available billable payment accounts to calling party. Site server then decides, in step 603, if site server receives a chosen billable payment account from the calling party, process proceeds to step 604; if site server receives no chosen billable payment account, process proceeds to step 613. In step 604, site server queries remote server to determine whether the chosen payment account is billable. Site server determines, after querying remote server, in step 605, if the chosen payment account is billable, process proceeds to step 611; if the chosen payment account is not billable, process proceeds to step 606. In step 606, site server prompts the calling party to choose another payment account to pay for the call. In step 607, site server determines, if a chosen payment account by the calling party is received, process proceeds to step 608; if no chosen payment account is received, process proceeds to step 613. In step 609, site server determines, after querying remote server, if the chosen payment account is billable, process proceeds to step 611; if the chosen payment account is not billable, process proceeds to step 610. In step 610, site server queries remote server to determine whether the phone number, dialed by the calling party, is billable. Site server then determines, in step 612, if the phone number is billable, process proceeds to step 611; if the phone number is not billable, process proceeds to step 613. In step 613, site server provides the calling party an option to manage payment accounts. Site server further determines, in step 614, if a decision to manage the payment account is not received, process proceeds to step 615; if a decision is received, step proceeds to step 616. In step 616, site server provides information of payment accounts to the calling party, accepts any input from the calling party, and updates user accounts of the calling party and depositor account of the associated depositor. Further, process returns to step 602.

In various embodiments, depending on the number of different payment accounts associated with the calling party, steps 606-608 may be repeated more than one time to query all the payment accounts. The specific order of querying different payment accounts should be based on different application and design requirements and should not be limited by the embodiments of the present disclosure.

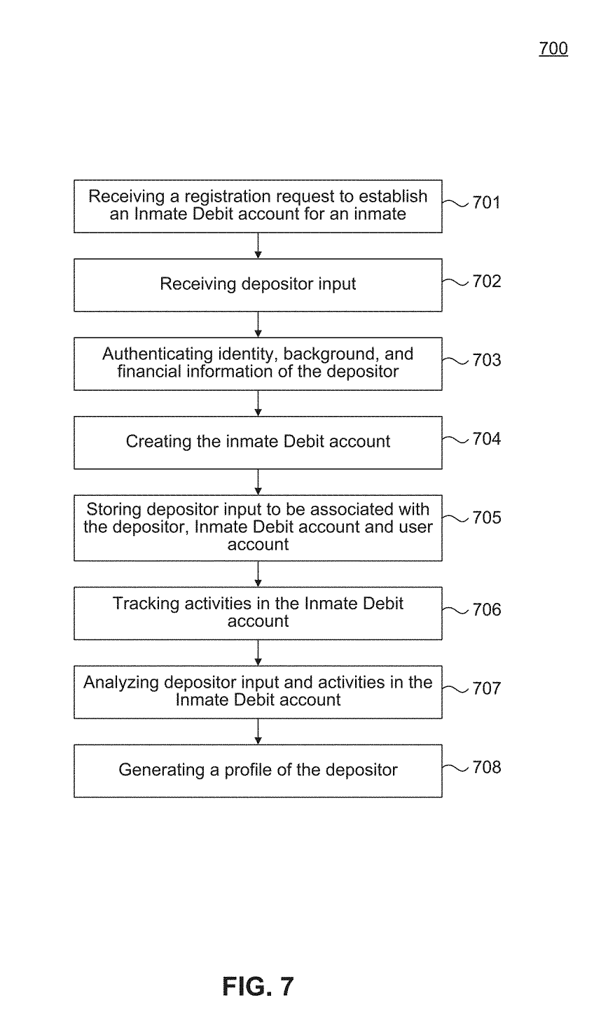

FIG. 7 illustrates a process 700 to collect depositor information using system 100, according to the embodiments of the present disclosure.

In step 701, site server receives a registration request, from a depositor, to establish an Inmate Debit account for an inmate. Receiving the registration request, in step 702, site server receives depositor input, including personal information, background information, and bank account information. Receiving the depositor input, in step 703, site server authenticates the identity, background, and financial information of the depositor, e.g., through a third party search and analysis engine. In step 704, site server creates the Inmate Debit account associated with the depositor. In step 705, site server stores the depositor input to be associated with the depositor, the inmate, and the Inmate Debit account. In step 706, site server monitors and tracks account activities in the Inmate Debit account. In step 707, site server analyzes the stored depositor input and activities in the Inmate Debit account. In step 708, site server generates a profile of the depositor. The profile reflects the security level, financial status, behavioral pattern of the depositor, and other characteristics.

In the description of the present disclosure, terms “inmate”, “user”, “calling party” party can be interchangeable based on context. The specific wording should not limit the scope of the present disclosure.

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

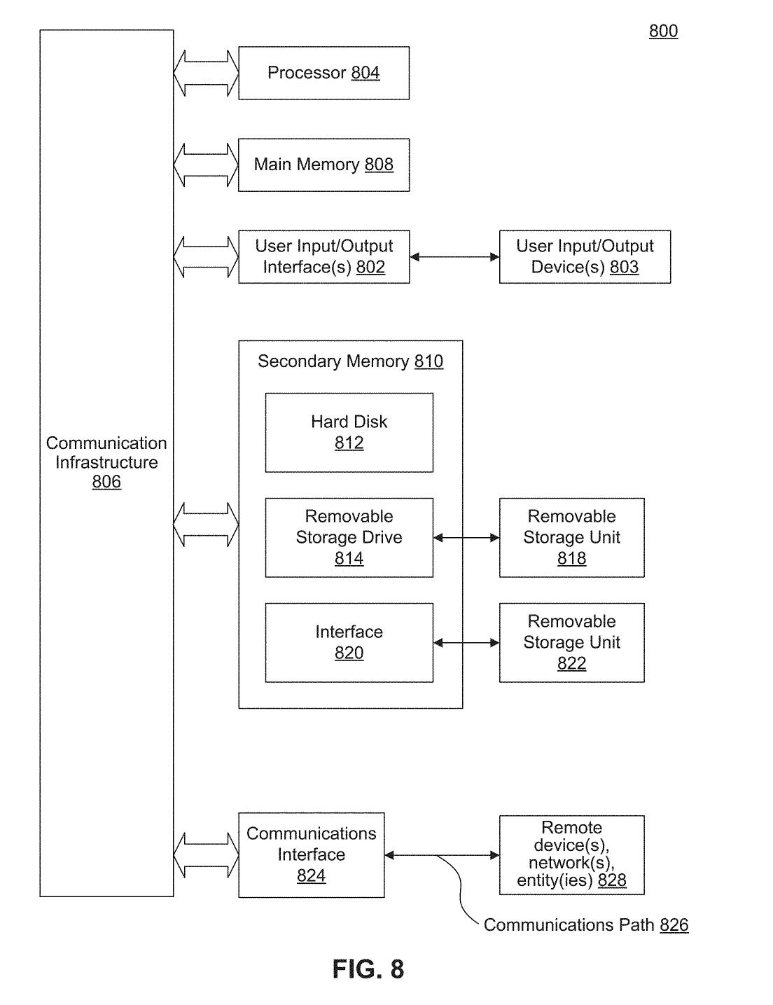

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, site server and remote server of FIGS. 1, 2, and 4, and methods of FIGS. 5, 6, and 7 can be implemented in the environment of one or more computer systems or other processing systems. An example of such a computer system 800 is shown in FIG. 8. One or more of the modules depicted in the previous figures can be at least partially implemented on one or more distinct computer systems 800.

Computer system 800 includes one or more processors, such as processor 804. Processor 804 can be a special purpose or a general purpose digital signal processor. Processor 804 is connected to a communication infrastructure 806 (for example, a bus or network). Various software implementations are described in terms of this exemplary computer system. After reading this description, it will become apparent to a person skilled in the relevant art(s) how to implement the disclosure using other computer systems and/or computer architectures.

Computer system 800 also includes a main memory 808, preferably random access memory (RAM), and may also include a secondary memory 810. Secondary memory 810 may include, for example, a hard disk drive 810 and/or a removable storage drive 814, representing a floppy disk drive, a magnetic tape drive, an optical disk drive, or the like. Removable storage drive 814 reads from and/or writes to a removable storage unit 818 in a well-known manner. Removable storage unit 818 represents a floppy disk, magnetic tape, optical disk, or the like, which is read by and written to by removable storage drive 814. As will be appreciated by persons skilled in the relevant art(s), removable storage unit 822 includes a computer usable storage medium having stored therein computer software and/or data.

In alternative implementations, secondary memory 810 can include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, a thumb drive and USB port, and other removable storage units 822 and interfaces 820 which allow software and data to be transferred from removable storage unit 822 to computer system 800.

Computer system 800 also includes user input/out interface(s) 802 which provide an interface to user input/output device(s) 803. Such user input/output device(s) 803 may be any device that provides a user access to input and output of computer system 800. Examples of user input/output device(s) 803 may include a keyboard, a computer monitor, a mouse, a camera, and a microphone.

Computer system 800 also includes a communications interface 824. Communications interface 824 allows software and data to be transferred between computer system 800 and external devices 828 which can include remote device(s), other network(s), and other entities. Examples of communications interface 824 can include a modem, a network interface (such as an Ethernet card), a communications port, a PCMCIA slot and card, etc. Software and data transferred via communications interface 824 are in the form of signals which can be electronic, electromagnetic, optical, or other signals capable of being received by communications interface 824. These signals are provided to communications interface 824 via a communications path 826. Communications path 826 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 818 and 822 or a hard disk installed in hard disk drive 810. These computer program products are means for providing software to computer system 800.

Computer programs (also called computer control logic) are stored in main memory 808 and/or secondary memory 810. Computer programs can also be received via communications interface 824. Such computer programs, when executed, enable the computer system 800 to implement the present disclosure as discussed herein. In particular, the computer programs, when executed, enable processor 804 to implement the processes of the present disclosure, such as any of the methods described herein. Accordingly, such computer programs represent controllers of the computer system 800. Where the disclosure is implemented using software, the software may be stored in a computer program product and loaded into computer system 800 using removable storage drive 814, interface 820, or communications interface 824.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

1. A system for customizing usage restriction rules in a user account for an inmate in a controlled environment, the system comprising:
a transceiver configured to facilitate voice calls via a communication network;
a communication interface connected to a database that stores inmate information for identifying an inmate, the user account associated with the inmate, and a plurality of usage restriction rules; and
one or more processors configured to:
receive a registration request and a user input from a user, wherein the user input includes a voice call restriction rule;
authenticate an identity of the user based on the user input and the inmate information stored in the database;
store the user input;
create an Inmate account associated with the inmate based on the user input and the inmate information;
create a plurality of partitions in the Inmate account based on the voice call restriction rule of the user input;
update the user account to include the Inmate account;
receive a voice call initiation request from an inmate; and
in response to receiving the voice call initiation request, restrict usage of at least one of the plurality of partitions based on the voice call restriction rule of the user input.

2. The system of claim 1, wherein the voice call restriction rule includes a selection from the plurality of usage restriction rules stored in the database.

3. The system of claim 1, wherein the voice call restriction rule is customized by the user.

4. The system of claim 1, wherein the voice call restriction rule restricts inmate fund usage from the at least one of the plurality of partitions.

5. The system of claim 1, wherein the voice call restriction rule includes at least one of: setting a maximum spending amount, limiting a phone number of a called party, limiting a purchase type, and limiting funds transfer.

6. The system of claim 1, wherein the user input includes at least one of: a legal name of the user, biometric samples of the user, a social security number (SSN) of the user, a home address of the user, a relationship between the user and the inmate, a criminal record of the user, and bank information of the user.

7. The system of claim 6, wherein authenticating an identity of the user based on the user input includes:
authorizing a third party search and analysis engine to verify at least one of: the legal name, biometric samples, the SSN, the home address of the user, the relationship between the user and the inmate, and the criminal record of the user.

8. The system of claim 7, wherein the one or more processors are further configured to send an alert in response to authentication failure of the identity of the user.

9. The system of claim 1, wherein the one or more processors are further configured to perform analysis including:
tracking activities in the Inmate account;
generating a report reflecting the activities in the Inmate account;
sending an alert based on the activities in the Inmate account; and
freezing the Inmate account based on the activities in the Inmate account.

10.-13. (canceled)

14. A method implemented by an inmate account-managing system for customizing usage restriction rules in a user account for an inmate in a controlled environment, the method comprising:
receiving, by one or more processors, a registration request and a user input from a user, wherein the user input includes a voice call restriction rule;
authenticating, by the one or more processors, an identity of the user based on the user input and inmate information for identifying an inmate, from a communication interface;
storing, by the one or more processors, the user input;
creating, by the one or more processors, an Inmate account associated with the inmate based on the user input and the inmate information;
creating, by the one or more processors, a plurality of partitions in the Inmate account based on the voice call restriction rule of the user input;
updating, by the one or more processors, the user account from the communication interface, associated with the inmate to include the Inmate account;
receiving, by the one or more processors, a voice call initiation request from an inmate; and
in response to receiving the voice call initiation request, restricting, by the one or more processors, usage of at least one of the plurality of partitions based on the voice call restriction rule of the user input and a plurality of usage restriction rules from the communication interface.

15. The method of claim 14, wherein the voice call restriction rule includes a selection from the plurality of usage restriction rules stored in the database.

16. The method of claim 14, wherein the voice call restriction rule restricts inmate fund usage from the at least one of the plurality of partitions.

17. The method of claim 14, wherein the voice call restriction rule includes at least one of: setting, by the one or more processors, a maximum spending amount, limiting a phone number of a called party, limiting a purchase type, and limiting funds transfer.

18. The method of claim 14, wherein the user input includes at least one of: a legal name of the user, biometric samples of the user, a social security number (SSN) of the user, a home address of the user, a relationship between the user and the inmate, a criminal record of the user, and bank information of the user.

19. The method of claim 18, further comprising:
authorizing, by the one or more processors, a third party search and analysis engine to verify at least one of: the legal name, biometric samples, the SSN, the home address of the user, the relationship between the user and the inmate, and the criminal record of the user.

20. The method of claim 14, further comprising:
tracking, by the one or more processors, activities in the Inmate account;
generating, by the one or more processors, a report reflecting the activities in the Inmate account;
sending, by the one or more processors, an alert based on the activities in the Inmate account; and
freezing, by the one or more processors, the Inmate account based on the activities in the Inmate account.
